(19) United States
(12) Patent Application Publication
(10) Pub. No.: US 2025/0142533 A1
(43) Pub. Date: May 1, 2025

(54) A METHOD AND APPARATUS FOR SELECTING RESOURCES BASED ON ASSISTANCE INFORMATION, AND STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN); Liangang CHI, Beijing (CN)

(21) Appl. No.: 18/687,747

(22) PCT Filed: Sep. 1, 2021
(86) PCT No.: PCT/CN2021/116064

§ 371 Date: Feb. 28, 2024

(51) Int. Cl. H04W 72/02; H04B 17/318; H04W 72/25; H04W 72/51

(52) U.S. Cl. CPC H04W 72/02; H04B 17/328; H04W 72/25; H04W 72/51

(57) ABSTRACT

A method for selecting resources based on assistance information is performed by a first user equipment, and includes: sending control information, where the control information includes field information used for determining a second user equipment, and the second user equipment includes a user equipment that provides the first user equipment with assistance information.

### BACKGROUND OF THE INVENTION

In enhancement of a sidelink of a new radio (NR), a third generation partnership (3GPP) working group has reached the conclusion that it is necessary to study a method for assisting in selecting resources between user equipments in the aspect of enhancing resource allocation of mode 2.

### SUMMARY OF THE INVENTION

The disclosure provides a method and apparatus for selecting resources based on assistance information, and a storage medium.

According to a first aspect of an example of the disclosure, a method for selecting resources based on assistance information is provided. The method is executed by a first user equipment, and includes: sending control information, where the control information includes field information configured to determine a second user equipment, and the second user equipment includes a user equipment providing assistance information for the first user equipment.

According to a second aspect of an example of the disclosure, a method for selecting resources based on assistance information is provided. The method is executed by a second user equipment, and includes:
receiving control information sent by a first user equipment, where the control information includes field information configured to determine the second user equipment; and providing assistance information for the first user equipment based on the field information included in the control information.

According to a third aspect of an example of the disclosure, an apparatus for selecting resources based on assistance information is provided. The apparatus includes:
a processor; and a memory configured to store a processor-executable instruction, where
the processor is configured to execute the method for selecting resources based on assistance information of the first aspect or any embodiment of the first aspect.

According to a fourth aspect of an example of the disclosure, an apparatus for selecting resources based on assistance information is provided. The apparatus includes:
a processor; and a memory configured to store a processor-executable instruction, where

the processor is configured to execute the method for selecting resources based on assistance information of the second aspect or any embodiment of the second aspect.

According to a fifth aspect of an example of the disclosure, a storage medium is provided. The storage medium stores an instruction, where the instruction in the storage medium enables a first user equipment to execute the method for selecting resources based on assistance information of the first aspect or any embodiment of the first aspect when executed by a processor of the first user equipment.

According to a sixth aspect of an example of the disclosure, a storage medium is provided. The storage medium stores an instruction, where the instruction in the storage medium enables a second user equipment to execute the method for selecting resources based on assistance information of the second aspect or any embodiment of the second aspect when executed by a processor of the second user equipment.

It should be understood that the above general description and the following detailed description are only illustrative and explanatory, and cannot limit the disclosure.

### BRIEF DESCRIPTION OF DRAWINGS

The accompanying drawings here, which are incorporated in the description as a constituent part of the description, illustrate the examples satisfying the disclosure and are used to explain the principle of the disclosure together with the description.

FIG. 1 is a schematic diagram of a direct communication system shown according to an example.

FIG. 2 is a flow chart of a method for selecting resources based on assistance information shown according to an example.

FIG. 3 is a flow chart of a method for selecting resources based on assistance information shown according to an example.

FIG. 4 is a flow chart of a method for selecting resources based on assistance information shown according to an example.

FIG. 5 is a flow chart of a method for selecting resources based on assistance information shown according to an example.

FIG. 6 is a flow chart of a method for selecting resources based on assistance information shown according to an example.

FIG. 7 is a flow chart of a method for selecting resources based on assistance information shown according to an example.

FIG. 8 is a flow chart of a method for selecting resources based on assistance information shown according to an example.

FIG. 9 is a flow chart of a method for selecting resources based on assistance information shown according to an example.

FIG. 10 is a flow chart of a method for selecting resources based on assistance information shown according to an example.

FIG. 11 is an example diagram of determination of a user equipment A (UE-A) by means of a zone identity (ID) shown according to an example.

FIG. 12 is an example diagram of determination of a UE-A by means of a reference signal receiving power (RSRP) threshold and/or an angle value shown according to an example.

FIG. 13 is an example diagram of determination of a UE-A by means of a member ID shown according to an example.

FIG. 14 is a block diagram of an apparatus for selecting resources based on assistance information shown according to an example.

FIG. 15 is a block diagram of an apparatus for selecting resources based on assistance information shown according to an example.

FIG. 16 is a block diagram of an apparatus for selecting resources based on assistance information shown according to an example.

### DETAILED DESCRIPTION OF THE INVENTION

The examples will be described in detail here and illustratively shown in the accompanying drawings. When the following descriptions relate to the accompanying drawings, unless otherwise specified, the same numeral in different accompanying drawings denotes the same or similar element. The embodiments described in the following examples do not denote all embodiments consistent with the disclosure. On the contrary, the embodiments are merely examples of an apparatus and a method consistent with some aspects of the disclosure as detailed in the appended claims.

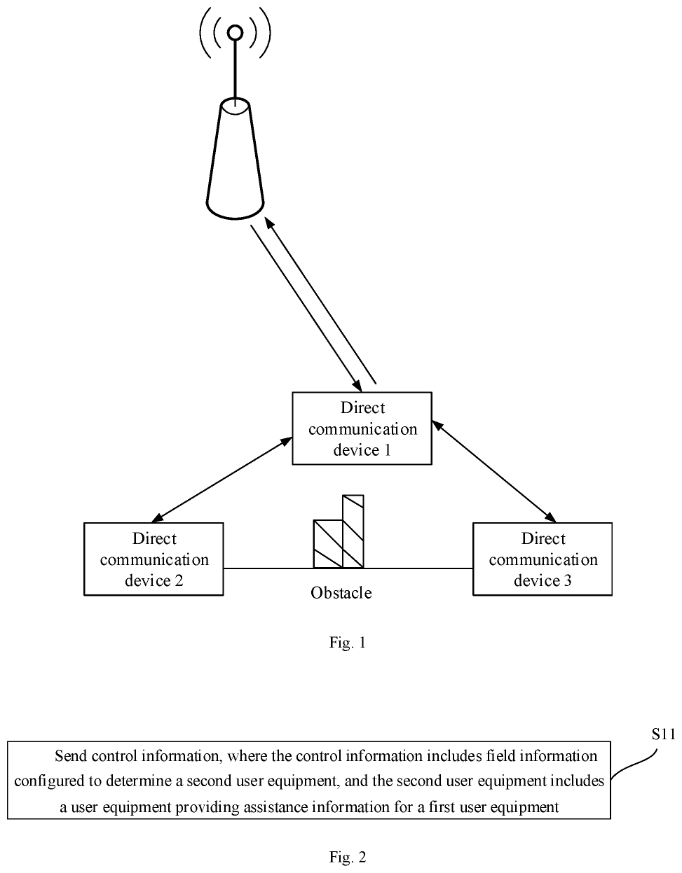

A method for selecting resources based on assistance information according to an example of the disclosure may be applied to a direct communication system shown in FIG. 1. With reference to FIG. 1, a network device configures various transmission parameters configured to transmit data for a direct communication device 1 in a scenario of direct communication between direct communication devices. The direct communication device 1, a direct communication device 2, and a direct communication device 3 perform direct communication. An obstacle may exist between the direct communication device 2 and the direct communication device 3. A link for communication between the network device and the direct communication device is an uplink and downlink, and a link between the direct communication devices is a sidelink.

In the method for assisting in selecting resources between user equipments, two user equipments, such as a user equipment A and a user equipment B, can be determined. The user equipment A is an auxiliary user equipment of the user equipment B. The user equipment B is a user equipment that needs to select resources for data transmission. The user equipment A for sidelink can send assistance information to the user equipment B having the method for selecting resources being mode 2, which considers resource selection for data transmission. However, the related art has no implementation plan for how to determine the user equipment A as an auxiliary user equipment.

The disclosure relates to the technical field of communications, and in particular to a method and apparatus for selecting resources based on assistance information, and a storage medium. In the disclosure, a communication scenario for direct communication between the direct communication devices may be a vehicle to everything (V2X) service scenario. V represents a vehicle-mounted device, and X represents any object interacting with the vehicle-mounted device. Currently, X mainly includes the vehicle-mounted device, a handheld device, a traffic roadside infrastructure and a network. An information mode of V2X interaction includes interaction between vehicle to vehicle (V2V), vehicle to infrastructure (V21), vehicle to pedestrian (V2P), and vehicle to network (V2N).

With development of a new generation of fifth-generation (5G) mobile communication technology, new V2X communication services and scenarios, such as vehicles platooning, extended sensors, advanced driving, and remote driving, are supported through 5G new radio (NR) technology in a third generation partnership (3GPP) Rel-16. In general, a 5G V2X sidelink can provide a higher communication rate, a shorter communication delay, and a more reliable communication quality.

The communication scenario for direct communication between direct communication devices may be a device to device (D2D) communication scenario. The direct communication device for direct communication in the example of the disclosure may include various handheld devices, vehicle-mounted devices, wearable devices, computing devices or other processing devices connected to wireless modems, which have wireless communication functions, as well as various forms of user equipment (UE), mobile stations (MSs), terminals, and terminal equipment. For convenience of description, the direct communication device as a user equipment will be described below as an example in the example of the disclosure.

Enhancement of the sidelink of the NR may improve transmission reliability and reduce delay. In enhancement of the sidelink of the new radio (NR), a 3GPP working group has reached the conclusion that it is necessary to study a method for assisting in selecting resources between user equipments in the aspect of enhancing resource allocation of mode 2. In this way, two user equipments are defined. For example, a user equipment A is an auxiliary user equipment of a user equipment B, and the user equipment B is a user equipment that needs to select resources for data transmission. The user equipment A provides assistance information, and sends the assistance information to the user equipment B in a mode of mode 2. When the user equipment B selects resources, the user equipment B considers the assistance information sent by the user equipment A. That is, it may be understood that the user equipment B selects resources through an assistance information assistance mechanism. The user equipment B may send data to the user equipment A and/or other user equipments.

However, how to determine the user equipment providing the assistance information is not discussed in a communication method for selecting resources based on assistance information in the related art. That is, there is no solution for determining the user equipment A providing the assistance information in the solution for selecting resource based on assistance information between terminals. Thus, it is necessary to design a method for determining a user equipment providing assistance information.

The example of the disclosure provides the method for selecting resources based on assistance information. In the method, the user equipment selecting resources sends information configured to determine the user equipment providing the assistance information, so as to determine the user equipment providing the assistance information. Thus, according to the disclosure, the user equipment providing the assistance information can be determined such that the resources can be selected between terminals based on the assistance information.

The method for selecting resources based on assistance information may also be understood as a method for determining an auxiliary user equipment in inter-UE auxiliary resource selection.

For convenience of description in the example of the disclosure, a user equipment receiving the assistance information and selecting resources for data sent by the user equipment based on the assistance information is referred to as a first user equipment, and a user equipment providing the assistance information is referred to as a second user equipment. That is, the second user equipment provides the assistance information for the first user equipment, and the first user equipment communicates with the second user equipment based on the assistance information, which may also be understood as resource selection between the first user equipment and the second user equipment based on the assistance information.

FIG. 2 is a flow chart of a method for selecting resources based on assistance information shown according to an example. The method for selecting resources based on assistance information can be executed separately, or in combination with other examples of the disclosure together. As shown in FIG. 2, the method for selecting resources based on assistance information is executed by a first user equipment, and includes:

S11, send control information, where the control information includes field information configured to determine a second user equipment.

In an example of the disclosure, the second user equipment includes a user equipment providing assistance information for the first user equipment. That is, the second user equipment providing the assistance information may be determined by means of the field information carried in the control information, and the second user equipment provides the assistance information for the first user equipment, such that an assistance information based communication process for selecting resources may be performed between the first user equipment and the second user equipment.

The process of determining the second user equipment will be described below in conjunction with practical application in an example of the disclosure.

In the example of the disclosure, the first user equipment may designate a user equipment in a geographic location zone as the second user equipment.

In an embodiment, a first user equipment may designate a user equipment in a geographical location zone as the second user equipment by means of a geographical location zone identity (ID).

In an example, the example of the disclosure may design new sidelink control information (SCI). For example, second stage sidelink control information (second stage SCI) carries a zone ID field in the SCI newly designed. The geographical location zone is indicated by means of the zone ID. The second user equipment providing the assistance information is determined in the geographical location zone indicated by the zone ID.

Further, in order to enable the second user equipment to determine an object (first user equipment) sending the assistance information, the SCI newly designed may carry an assisted ID of the first user equipment.

Furthermore, multiple user equipments may exist in the geographical location zone indicated by the zone ID. In order to determine the second user equipment in the plurality of user equipments, in one aspect, a probability factor is designed in the example of the disclosure. The probability factor is carried in the SCI newly designed. A user equipment in the geographical location zone indicated by the zone ID randomly generates the probability factor, and a user equipment in which the probability factor randomly generated and the probability factor carried in the SCI satisfy a preset size relation is determined as the second user equipment. The preset size relation satisfied by the probability factor randomly generated and the probability factor carried in the SCI may be that the probability factor randomly generated is greater than the probability factor carried in the SCI, or that the probability factor randomly generated is equal to the probability factor carried in the SCI, or that the probability factor randomly generated is less than the probability factor carried in the SCI.

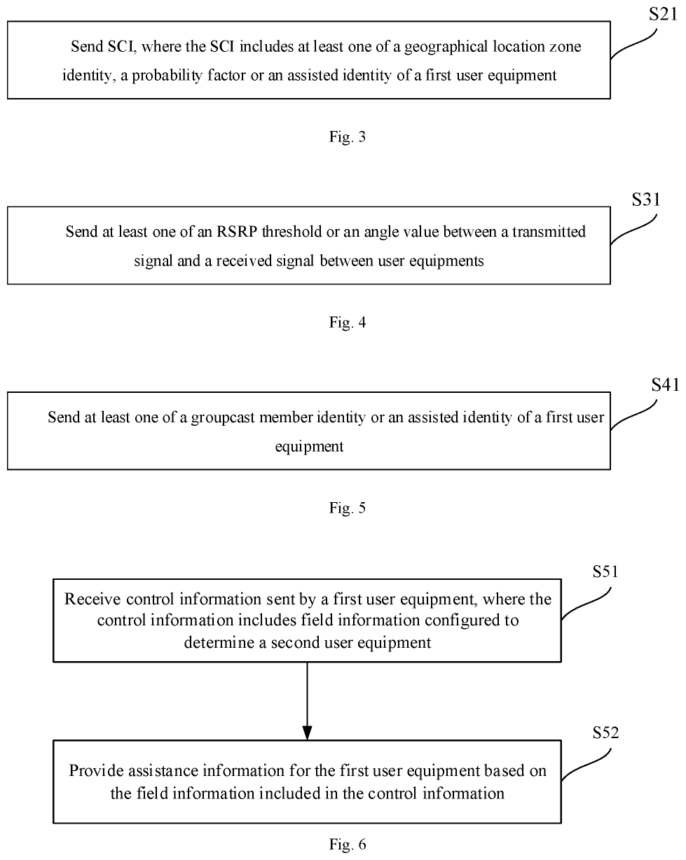

FIG. 3 is a flow chart of a method for selecting resources based on assistance information shown according to an example. The method for selecting resources based on assistance information can be executed separately, or in combination with other examples of the disclosure together. As shown in FIG. 3, the method for selecting resources based on assistance information is executed by a first user equipment, and includes:

S21, send SCI, where the SCI includes at least one of a zone ID, a probability factor or an assisted ID of the first user equipment.

The SCI including field information of the zone ID, the probability factor, the assisted ID, etc. may be second stage SCI.

The SCI including the field information of the zone ID, the probability factor, the assisted ID, etc. is sent in a form of broadcast such that a plurality of user equipments can receive the SCI configured to determine a second user equipment.

In an embodiment, a probability factor set is preconfigured in the example of the disclosure. For example, the probability factor set is preconfigured by means of radio resource control (RRC). A network device may preconfigure the probability factor set for each user equipment based on a user equipment identity. The network device may also preconfigure a probability factor set for each cell based on a cell identity. That is, the probability factor set is determined based on the user equipment identity and/or the cell identity, and each user equipment identity and/or each cell identity have/has a corresponding probability factor set.

One or more probability factors may be determined in the preconfigured probability factor set as probability factors included in SCI in the example of the disclosure. That is, the probability factor included in the SCI may be one or more probability factors in the preconfigured probability factor set.

In the example of the disclosure, under the condition that the first user equipment predicts the second user equipment, the first user equipment may determine the probability factor included in the SCI in the probability factor set corresponding to the user equipment identity of the second user equipment, or the first user equipment may determine the probability factor included in the SCI in the probability factor set corresponding to the cell identity of the cell to which the second user equipment belongs.

In another embodiment, a first user equipment may designate a user equipment in the geographical location zone as a second user equipment by means of a reference signal receiving power (RSRP) threshold and/or an angle value between a transmitted signal and a received signal between two user equipments. That is, the first user equipment sends the RSRP threshold and/or the angle value between the transmitted signal and the received signal between two user equipments, such that other user equipments determine whether being the second user equipment providing the assistance information based on the RSRP threshold and/or the angle value.

In an example, in order to enable the second user equipment to determine the object (first user equipment) sending the assistance information, the first user equipment may send an assisted ID of the first user equipment.

FIG. 4 is a flow chart of a method for selecting resources based on assistance information shown according to an example. The method for selecting resources based on assistance information can be executed separately, or in combination with other examples of the disclosure together. As shown in FIG. 4, the method for selecting resources based on assistance information is executed by a first user equipment, and includes:

S31, send at least one of an RSRP threshold or an angle value between a transmitted signal and a received signal between user equipments.

Field information such as the RSRP threshold and/or the angle value may be included in SCI, and for example, may be included in second stage SCI.

The field information such as the RSRP threshold and/or the angle value is sent in a form of broadcast, such that a plurality of user equipments may receive the field information.

In an embodiment, the RSRP threshold and/or the angle value are/is preconfigured in the example of the disclosure. For example, a parameter set is preconfigured by means of RRC. A network device may preconfigure a parameter set for each user equipment based on a user equipment identity. The network device may also preconfigure a parameter set for each cell based on a cell identity. That is, the parameter set is determined based on the user equipment identity and/or the cell identity, and each user equipment identity and/or the cell identity have/has a corresponding parameter set.

The RSRP threshold and/or the angle value may be determined in a preconfigured parameter set in the example of the disclosure. That is, the RSRP threshold and/or the angle value configured to determine the second user equipment may be determined by the preconfigured parameter set.

In the example of the disclosure, under the condition that the first user equipment predicts the second user equipment, the first user equipment may determine the RSRP threshold and/or the angle value configured to determine the second user equipment in the parameter set corresponding to the user equipment identity of the second user equipment, or the first user equipment may determine the RSRP threshold and/or the angle value configured to determine the second user equipment in the parameter set corresponding to the cell identity of the cell to which the second user equipment belongs.

In yet another embodiment of the example of the disclosure, the first user equipment may determine the second user equipment by indicating a member ID.

It may be understood that determination of the second user equipment by means of the member ID needs to have communication establishing a connection between the first user equipment and the second user equipment. For example, both the first user equipment and the second user equipment are user equipments based on groupcast communication. For example, the first user equipment communicates with the second user equipment based on a groupcast option 2.

In an example, in order to enable the second user equipment to determine the object (first user equipment) sending the assistance information, the first user equipment may send an assisted ID of the first user equipment.

FIG. 5 is a flow chart of a method for selecting resources based on assistance information shown according to an example. The method for selecting resources based on assistance information can be executed separately, or in combination with other examples of the disclosure together. As shown in FIG. 5, the method for selecting resources based on assistance information is executed by a first user equipment, and includes:

S41, send at least one of a member ID, and an assisted ID of the first user equipment.

The field information such as the member ID and the assisted ID of the first user equipment may be included in SCI, and for example, may be included in second stage SCI.

The field information such as the member ID and the assisted ID of the first user equipment is sent in a form of broadcast, such that a plurality of user equipments may receive the field information.

In an embodiment, one or more member IDs are provided in the example of the disclosure.

In an embodiment, a second user equipment indicated by a member ID may be a user equipment in the same groupcast as the first user equipment, or may be a user equipment in different groupcast from the first user equipment. That is, the second user equipment indicated by the member ID and the first user equipment are located in the same groupcast or in different groupcast.

It may be understood that in the example of the disclosure, after the first user equipment sends the SCI, the second user equipment determines that the second user equipment is the user equipment providing the assistance information, the second user equipment provides the assistance information for the first user equipment, and the first user equipment may receive the assistance information provided by the second user equipment, and select resources based on the assistance information provided by the second user equipment.

It may be further understood that the second user equipment involved in the example of the disclosure may be a receiving user equipment of direct communication data sent by the first user equipment for direct communication this time, or may not be a receiving user equipment of direct communication data sent by the first user equipment for direct communication this time.

A process of determining the second user equipment will be described below in the example of the disclosure.

FIG. 6 is a flow chart of a method for selecting resources based on assistance information shown according to an example. The method for selecting resources based on assistance information can be executed separately, or in combination with other examples of the disclosure together. As shown in FIG. 6, the method for selecting resources based on assistance information is executed by a second user equipment, and includes:

S51, receive control information sent by a first user equipment, where the control information includes field information configured to determine the second user equipment.

In an embodiment, the control information may be SCI, and may be second stage SCI, for example.

S52, provide assistance information for the first user equipment based on the field information included in the control information.

In the example of the disclosure, the second user equipment receiving the control information sent by the first user equipment may determine whether the second user equipment is a second user equipment communicating with the first user equipment based on the assistance information based on the field information configured to determine the second user equipment included in the control information.

In an example of the disclosure, the field information configured to determine the second user equipment may include a zone ID, a probability factor, and an assisted ID of the first user equipment. The second user equipment provides the assistance information for the first user equipment based on the zone ID, the probability factor, and the assisted ID of the first user equipment.

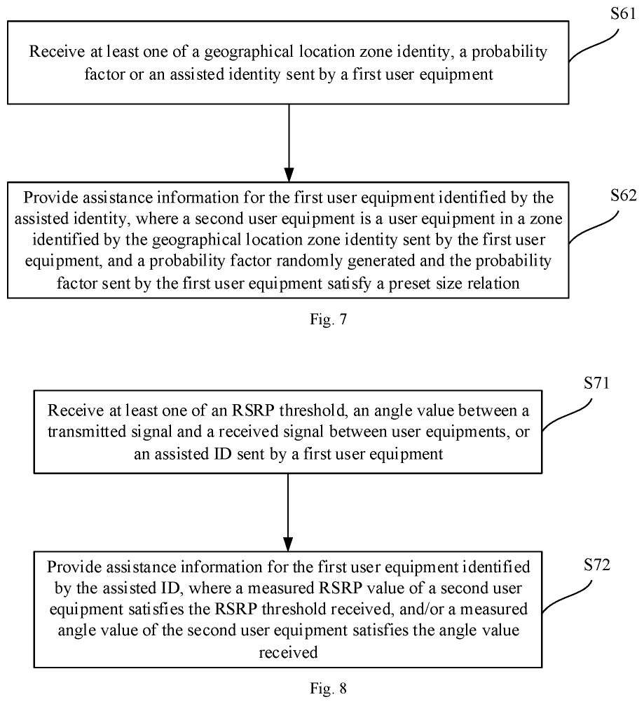

FIG. 7 is a flow chart of a method for selecting resources based on assistance information shown according to an example. The method for selecting resources based on assistance information can be executed separately, or in combination with other examples of the disclosure together. As shown in FIG. 7, the method for selecting resources based on assistance information is executed by a second user equipment, and includes:

S61, receive at least one of a zone ID, a probability factor, or an assisted ID sent by a first user equipment.

S62, provide assistance information for the first user equipment identified by the assisted ID. The second user equipment is a user equipment in a zone identified by the zone ID sent by the first user equipment, and a probability factor randomly generated and the probability factor sent by the first user equipment satisfy a preset size relation.

The preset size relation satisfied by the probability factor randomly generated and the probability factor carried in the SCI may be that the probability factor randomly generated is greater than the probability factor carried in the SCI, or that the probability factor randomly generated is equal to the probability factor carried in the SCI, or that the probability factor randomly generated is less than the probability factor carried in the SCI.

In an embodiment, the field information configured to determine a second user equipment may include an RSRP threshold and/or an angle value between a transmitted signal and a received signal between user equipments, and an assisted ID of the first user equipment.

FIG. 8 is a flow chart of a method for selecting resources based on assistance information shown according to an example. The method for selecting resources based on assistance information can be executed separately, or in combination with other examples of the disclosure together. As shown in FIG. 8, the method for selecting resources based on assistance information is executed by a second user equipment, and includes:

S71, receive at least one of an RSRP threshold, an angle value between a transmitted signal and a received signal between user equipments, or an assisted ID sent by a first user equipment.

S72, provide assistance information for the first user equipment identified by the assisted ID. A measured RSRP value of the second user equipment satisfies the RSRP threshold received and/or a measured angle value of the second user equipment satisfies the angle value received.

The measured RSRP value satisfies a preconfigured RSRP threshold. For example, a user equipment satisfying a condition of RSRP_threshold 1≤measured RSRP value≤RSRP_threshold 2 is used as the second user equipment, and/or a user equipment satisfying the angle value preconfigured is the second user equipment.

In an embodiment, field information configured to determine the second user equipment may include a member ID and an assisted ID of the first user equipment.

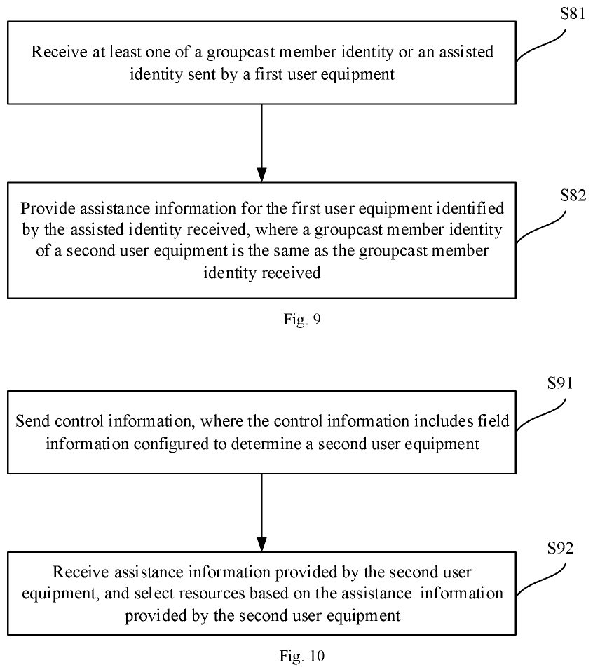

FIG. 9 is a flow chart of a method for selecting resources based on assistance information shown according to an example. The method for selecting resources based on assistance information can be executed separately, or in combination with other examples of the disclosure together. As shown in FIG. 9, the method for selecting resources based on assistance information is executed by a second user equipment, and includes:

S81, receive at least one of a member ID or an assisted ID sent by a first user equipment.

S82, provide assistance information for the first user equipment identified by the assisted ID received. The member ID of the second user equipment is the same as the member ID received.

It may be understood that in the example of the disclosure, a zone ID, a probability factor and an assisted ID, or an RSRP threshold and/or an angle value and an assisted ID, or the member ID and the assisted ID may be received based on SCI, for example, by means of second stage SCI.

In the example of the disclosure, the second user equipment may provide the assistance information for the first user equipment under the condition that the second user equipment determines that the user equipment selecting resources based on the assistance information is the first user equipment based on the assisted ID. The first user equipment selects resources based on the assistance information received.

FIG. 10 is a flow chart of a method for selecting resources based on assistance information shown according to an example. The method for selecting resources based on assistance information can be executed separately, or in combination with other examples of the disclosure together. As shown in FIG. 10, the method for selecting resources based on assistance information is executed by a first user equipment, and includes:

S91, send control information, where the control information includes field information configured to determine a second user equipment.

The control information may be second stage SCI.

The field information configured to determine the second user equipment may include a zone ID and a probability factor. Or, the field information configured to determine the second user equipment may include an RSRP threshold and/or an angle value between a transmitted signal and a received signal between two user equipments. Or, the field information configured to determine the second user equipment may include a member ID.

Further, the control information may further include an assisted ID of the first user equipment, such that the second user equipment determined may determine the object providing the assistance information as the first user equipment.

S92, receive the assistance information provided by the second user equipment, and selecting resources based on the assistance information provided by the second user equipment.

According to the method for selecting resources based on assistance information according to the example of the disclosure, the user equipment providing the assistance information may be determined.

In the example of the disclosure, the process of determining a user equipment (UE-A) in the method for selecting resources based on assistance information involved in the above example is further described below by taking the first user equipment as a user equipment B (UE-B) and the second user equipment as the UE-A as an example. The manners of determining the UE-A according to the example of the disclosure may include the following manners 1 and 2.

Manner 1: the UE-B designates a UE in a geographical location zone as the UE-A.

In an embodiment, the UE-B designates the UE-A by means of the zone ID.

The UE-B designates the UE-A by means of SCI newly designed, for example, second stage SCI newly designed.

For example, the zone ID field, the probability factor, and the assisted ID field are carried in the second stage SCI, and the message is sent in a form of broadcast.

The UE in the designated geographical location zone decodes the SCI received. UE belonging to an indicated zone ID zone and having a probability factor randomly generated greater than or equal to a probability factor carried in SCI is used as UE-A. The UE-A sends the assistance information to the corresponding UE-B according to the assisted ID field in the SCI.

The UE-A may be a UE receiving direct communication data (sidelink data) of the UE-B this time, or may not be a UE receiving sidelink data of the UE-B this time.

The probability factor is determined by a parameter set preconfigured by RRC. The parameter set is a parameter set preconfigured by a base station for each UE, and may be understood as a UE specific preconfigure. Alternatively, a UE preconfigure set by a base station for the UE of one cell may be understood as a cell preconfigure.

The UE-A is an auxiliary UE of the UE-B, or may also be an auxiliary UE of a user equipment C (UE-C). Thus, it is necessary to distinguish the assistance information sent by the UE-A to the UE-B from the assistance information sent by the UE-A to the UE-C according to the assisted ID. That is, the assisted ID carried in the SCI is configured to distinguish an object to which the UE-A sends the assistance information, and the UE-A sends the assistance information to the corresponding UE-B according to the ID.

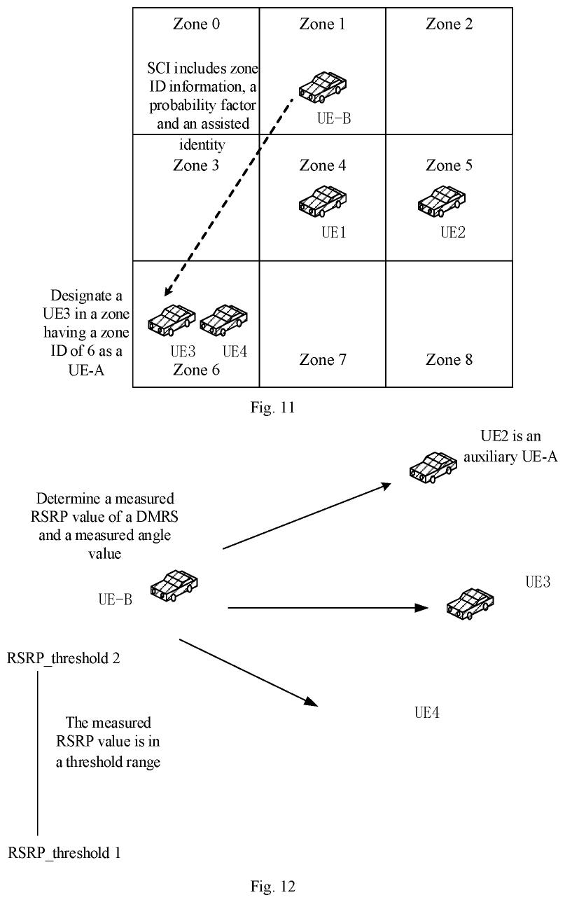

FIG. 11 is an example diagram of determination of a UE-A by means of a zone ID shown according to an example. With reference to FIG. 11, assuming that the UE-B designates a zone ID as 6 in SCI, a probability factor is 0.5. The zone ID designated corresponds to a zone of 6, in which a user equipment 3 (UE3) and a user equipment 4 (UE4) exist. The UE3 and the UE4 generate probability factors by means of random numbers. The probability factor generated by the UE3 is 0.6, and the probability factor generated by the UE4 is 0.3, such that the probability factor of the UE3 is greater than 0.5, and the UE3 is the UE-A.

In another embodiment, the UE-B designates the UE-A by means of an RSRP threshold and/or an angle value.

The UE-B determines a UE in a zone satisfying the condition of [RSRP_threshold 1≤measured RSRP value≤RSRP_threshold 2] preconfigured and/or a UE satisfying an angle value preconfigured by means of the measured RSRP value and/or the measured angle value to determine the UE-A.

In the example of the disclosure, the UE-B carries an RSRP threshold field and/or an angle value field, an assisted ID field, etc. by means of SCI newly designed.

The RSRP threshold and the angle value are preconfigured. For example, RRC preconfigures a parameter set, for example, a UE specific preconfigure by a base station or a cell preconfigure by a base station.

The assisted ID is configured to distinguish an object to which the UE-A sends the assistance information, and the UE-A sends the assistance information to the corresponding UE-B according to the assisted ID. For example, the UE-A is an auxiliary UE of the UE-B, or may also be an auxiliary UE of the UE-C. Thus, it is necessary to distinguish the assistance information sent by the UE-A to the UE-B from the assistance information sent by the UE-A to the UE-C according to the assisted ID.

FIG. 12 is an example diagram of determination of a UE-A by means of an RSRP threshold and/or an angle value shown according to an example. With reference to FIG. 12, a UE-B measures RSRP of a demodulation reference signal (DMRS) of a physical sidelink control channel (PSCCH) or measures RSRP of a DMRS of a physical sidelink share channel (PSSCH) by receiving SCI or data of other UEs in resource awareness of a mode 2 in R16. The UE-B obtains measured RSRP values of surrounding UEs. The measured RSRP value of the UE2 is in a predefined threshold range of [RSRP_threshold 1≤measured RSRP value≤RSRP_threshold 2].

An angle is measured for the UE-B. In implementation, the UE-B obtains measured angle values of surrounding UEs of the UE-B by means of an existing positioning method, such as an angle measurement method in positioning. For example, a preconfigured angle set {0, 1/2π, π, 3/2π, 2π}, the measured angle value carried in the SCI is 2 bits, and 11 indicates 2π. An angle value of the UE2 measured by the UE-B is 2π. Thus, the UE2 satisfies both the RSRP threshold and the angle value, and the UE2 is an auxiliary UE-A.

Manner 2: the UE-B determines the UE-A by indicating a member ID

The mode of determining the UE-A by indicating the member ID may be applicable to groupcast communication of groupcast option2.

In the example of the disclosure, the UE-B may carry fields such as the member ID and the assisted ID in the second stage SCI newly designed, and send the fields out in a form of broadcast. It may be understood that the UE indicated by the member ID carried in the second stage SCI is the UE-A.

The member ID carried in the second stage SCI broadcast by the UE-B may be one or more member IDs.

Further, the UE indicated by the member ID may be in the same group as the UE-B, or may not be in the same group as the UE-B.

The assisted ID carried in the second stage SCI broadcast by the UE-B is configured to distinguish an object to which the UE-A sends the assistance information, and the UE-A sends the assistance information to the corresponding UE-B according to the assisted ID. The assisted ID may be a source ID or other IDs of the UE-B.

The UE receiving the second stage SCI broadcast by the UE-B decodes the second stage SCI to obtain the member ID. The UE whose member ID is the same as a member ID decoded is used as an auxiliary UE-A. The UE-A sends the assistance information to the corresponding UE-B according to the assisted ID field in the SCI.

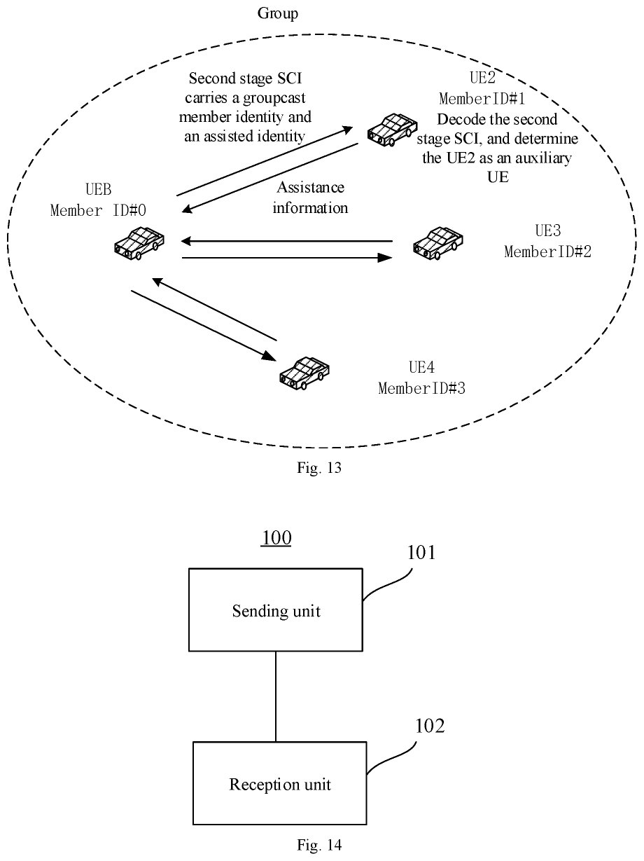

FIG. 13 is an example diagram of determination of a UE-A by means of a member ID shown according to an example. With reference to FIG. 13, in groupcast, UE-B carries a member ID in SCI. Assuming that the member ID carried in the SCI corresponds to a UE having a member ID of 1, a UE2 having a member ID of 1 in the same group as a UE-B and another UE having a member ID of 1 in other groups are UEs-A, and send assistance information to the UE-B according to an assisted ID.

In the example of the disclosure, the control information sent by the first user equipment includes field information configured to determine a second user equipment. The second user equipment providing assistance information can be newly determined by means of the field, such that an assistance information based communication method for selecting resources between terminals can be implemented.

It can be understood that the method for selecting resources based on assistance information according to the example of the disclosure is applicable to a scenario of interactive communication between user equipments and a scenario of interactive communication between the user equipment and a network device. The specific implementation process is similar to that of the above example, and thus is not described in detail here.

It should be noted that those skilled in the art can understand that various embodiments/examples mentioned above in the examples of the disclosure can be used in conjunction with the examples above, or can also be used independently. Whether various embodiments/examples are used separately or in conjunction with the examples above, the implementation principles are similar. In the implementation of the disclosure, some examples are described in terms of embodiments used together. Certainly, those skilled in the art can understand that such illustrations are not intended to limit examples of the disclosure.

Based on the same concept, an example of the disclosure further provides an apparatus for selecting resources based on assistance information.

It can be understood that in order to achieve the above functions, the apparatus for selecting resources based on assistance information according to the example of the disclosure includes a corresponding hardware structure and/or software module executing each function. In combination with the units and algorithm steps of various examples disclosed in the examples of the disclosure, the example of the disclosure can be implemented in hardware or a combination of hardware and computer software. Whether a function is executed by hardware or computer software driven hardware depends on the specific application and design constraints of the technical solution. Those skilled in the art can implement the functions described by using different methods for each specific application, but such implementations should not be considered as being beyond the scope of the technical solutions of the examples of the disclosure.

FIG. 14 is a block diagram of an apparatus for selecting resources based on assistance information shown according to an example. With reference to FIG. 14, the apparatus 100 for selecting resources based on assistance information includes a sending unit 101.

The sending unit 101 is configured to send control information, where the control information includes field information configured to determine a second user equipment, and the second user equipment includes a user equipment providing assistance information for a first user equipment.

In an embodiment, field information includes at least one of the following: a zone ID, a probability factor, or an assisted ID of a first user equipment.

In an embodiment, the probability factor is one or more probability factors in a probability factor set.

In an embodiment, a probability factor set is one or more probability factors in the probability factor set, the probability factor set is determined based on user equipment identities and/or cell identities, and each user equipment identity and/or each cell identity have/has a corresponding probability factor set.

In an embodiment, a probability factor is one or more probability factors in the probability factor set, and the probability factor set is a probability factor set corresponding to a user equipment identity of the second user equipment, or a probability factor set corresponding to a cell identity of a cell to which the second user equipment belongs.

In an embodiment, the field information includes at least one of the following: an RSRP threshold; an angle value between a transmitted signal and a received signal between user equipments; or an assisted ID of the first user equipment.

In an embodiment, the RSRP threshold and/or the angle value are/is determined based on a preconfigured parameter set.

In an embodiment, the RSRP threshold and/or the angle value are/is determined based on a preconfigured parameter set, the parameter set is determined based on user equipment identities and/or cell identities, and each user equipment identity and/or each cell identity have/has a corresponding parameter set.

In an embodiment, the RSRP threshold and/or the angle value are/is determined based on the preconfigured parameter set, and the parameter set is a parameter set corresponding to a user equipment identity of the second user equipment or a parameter set corresponding to a cell identity of a cell to which the second user equipment belongs.

In an embodiment, the field information includes at least one of the following: a member ID, or an assisted ID of the first user equipment.

In an embodiment, one or more member IDs are included in the control information.

In an embodiment, a user equipment identified by the member ID and the first user equipment are located in the same groupcast or in different groupcast.

In an embodiment, the sending unit 101 broadcasts a second stage SCI.

In an embodiment, the apparatus 100 for selecting resources based on assistance information further includes a reception unit 102. The reception unit 102 is configured to receive assistance information provided by the second user equipment and select resources on the basis of the assistance information.

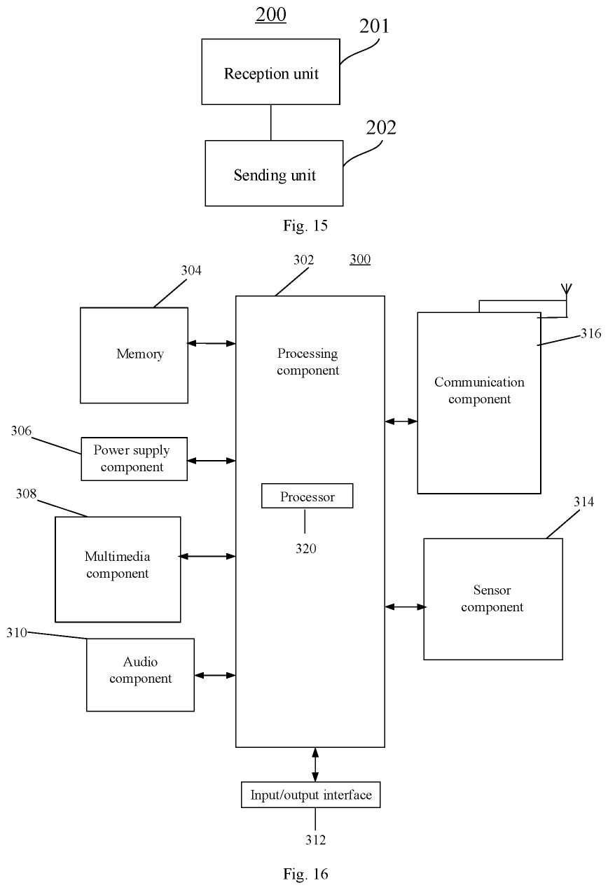

FIG. 15 is a block diagram of an apparatus for selecting resources based on assistance information shown according to an example. With reference to FIG. 15, the apparatus 200 for selecting resources based on assistance information includes a reception unit 201 and a sending unit 202.

The reception unit 201 is configured to receive control information sent by a first user equipment, where the control information includes field information configured to determine a second user equipment. The sending unit 202 is configured to provide assistance information for the first user equipment based on the field information included in the control information.

In an embodiment, field information includes at least one of the following: a zone ID, a probability factor, or an assisted ID of a first user equipment.

The sending unit 202 provides the assistance information for the first user equipment identified by the assisted ID. The second user equipment is a user equipment in a zone identified by the zone ID, and a probability factor randomly generated and the probability factor included in the control information satisfy a preset size relation.

In an embodiment, field information includes at least one of the following: an RSRP threshold; an angle value between a transmitted signal and a received signal between user equipments, or an assisted identity of the first user equipment.

The sending unit 202 provides the assistance information for the first user equipment identified by the assisted ID. A measured RSRP value of the second user equipment satisfies the RSRP threshold, and/or a measured angle value of the second user equipment satisfies the angle value included in the control information.

In an embodiment, field information includes at least one of the following: a member ID or an assisted identity of a first user equipment; and a sending unit 202 provides assistance information for the first user equipment identified by an assisted ID. A member identity of a second user equipment is the same as a member identity included in the control information.

In an embodiment, a reception unit 201 is configured to receive a second stage SCI broadcast by a first user equipment.

For the apparatus in the example above, a specific method for each module to execute an operation has been described in detail in the example relating to the method, and will not be repeated here.

FIG. 16 is a block diagram of an apparatus 300 for selecting resources based on assistance information shown according to an example. For example, the apparatus 300 may be a first user equipment or a second user equipment involved in the example of the disclosure above. The apparatus 300 may be a mobile phone, a computer, a digital broadcast terminal, a message sending and receiving device, a game console, a tablet device, a medical device, a fitness device, a personal digital assistant, etc.

With reference to FIG. 16, the apparatus 300 may include one or more of the following components: a processing component 302, a memory 304, a power supply component 306, a multimedia component 308, an audio component 310, an input/output (I/O) interface 312, a sensor component 314 and a communication component 316.

The processing component 302 generally controls overall operations of the apparatus 300, such as operations associated with display, phone calls, data communications, camera operations and recording operations. The processing component 302 may include one or more processors 320 to execute an instruction to complete all or some of the steps of the method described above. Further, the processing component 302 may include one or more modules that facilitate interaction between the processing component 302 and other components. For example, the processing component 302 may include a multimedia module, so as to facilitate interaction between the multimedia component 308 and the processing component 302.

The memory 304 is configured to store various types of data to support operations at the apparatus 300. Examples of such data include instructions, contact data, phone book data, messages, pictures, videos, etc., for any application or method operated on the apparatus 300. The memory 304 may be implemented by any type of volatile or non-volatile storage device, or a combination of any type of volatile or non-volatile storage device, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power supply component 306 provides power for various components of the apparatus 300. The power supply component 306 may include a power management system, one or more power supplies, and other components associated with generation, management and distribution of power for the apparatus 300.

The multimedia component 308 includes a screen that provides an output interface between the apparatus 300 and a user. In some examples, a screen may include a liquid crystal display (LCD) and a touch panel (TP). If the screen includes the TP, the screen may be implemented as a touch screen to receive an input signal from a user. The TP includes one or more touch sensors to sense touches, swiping, and gestures on the TP. The touch sensor may not only sense a boundary of a touch or swiping action, but also detect duration and pressure associated with the touch or swiping operation. In some examples, the multimedia component 308 includes a front camera and/or a rear camera. When the apparatus 300 is in an operation mode, such as a photographing mode or a video mode, the front camera and/or the rear camera may receive external multimedia data. Each front camera and each rear camera may be a fixed optical lens system or have a focal length and an optical zoom capability.

The audio component 310 is configured to output and/or input an audio signal. For example, the audio component 310 includes a microphone (MIC). The MIC is configured to receive an external audio signal when the apparatus 300 is in an operating mode, such as call mode, recording mode, and voice recognition mode. The received audio signal may be further stored in the memory 304 or transmitted via the communication component 316. In some examples, the audio component 310 further includes a loudspeaker, configured to output an audio signal.

The I/O interface 312 provides an interface between the processing component 302 and a peripheral interface module. The peripheral interface module described above may be a keyboard, a click wheel, a button, etc. The button may include, but not limited to, a home button, a volume button, a start button, and a lock button.

The sensor component 314 includes one or more sensors, configured to provide state assessments of various aspects for the apparatus 300. For example, the sensor component 314 may detect an open/closed state of the apparatus 300, and a relative positioning effect of components. For example, the component is a display and a keypad of the apparatus 300. The sensor component 314 may further detect a change in position of the apparatus 300 or a component of the apparatus 300, presence or absence of the user making contact with the apparatus 300, orientation or acceleration/deceleration of the apparatus 300, and a change in temperature of the apparatus 300. The sensor component 314 may include a proximity sensor configured to detect presence of nearby objects in the absence of any physical contact. The sensor component 314 may further include a light sensor, such as a complementary metal-oxide-semiconductor (CMOS) image sensor or a charge coupled device (CCD) image sensor, used in imaging applications. In some examples, the sensor component 314 may further include an acceleration sensor, a gyro sensor, a magnetic sensor, a pressure sensor, or a temperature sensor.

The communication component 316 is configured to facilitate communication between the apparatus 300 and other devices in a wired or wireless manner. The apparatus 300 may access a wireless network based on a communication standard, such as wireless fidelity (WiFi), second-generation (2G), third-generation (3G), or a combination of the WiFi, the 2G and the 3G. In an example, the communication component 316 receives a broadcast signal or broadcast related information from an external broadcast management system via a broadcast channel. In an example, the communication component 316 further includes a near field communication (NFC) module to facilitate short range communication. For example, the NFC module may be implemented on the basis of a radio frequency identification (RFID) technology, an infrared data association (IrDA) technology, an ultra wide band (UWB) technology, a Bluetooth (BT) technology, and other technologies.

In an example, the apparatus 300 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is configured to execute the methods described above.

In an example, a non-transitory computer-readable storage medium including an instruction is further provided, such as the memory 304 including an instruction. The instruction is executable by the processor 320 of the apparatus 300, so as to complete the method. For example, the non-transitory computer-readable storage medium may be a ROM, a RAM, a compact disc read-only memory (CD-ROM), a magnetic tape, a floppy disk, an optical data storage device, etc.

Further, it can be understood that “a plurality” in the disclosure refers to two or more, and other quantifiers are similar to the term. “And/or” describes an associated relation of an associated object, and indicates that three relations may exist. For example, A and/or B may indicate that A exists separately, A and B exist at the same time, and B exists separately. The character “/” generally indicates that the context object is an “or” relation. The singular forms such as “a”, “the” and “this” are also intended to include the plural forms, unless otherwise clearly stated in the context.

Further, it can be understood that the terms “first”, “second”, etc. are used to describe various information, but these pieces of information are not limited by these terms. These terms are merely used to distinguish the same type of information from each other, and do not indicate a particular order or importance. In fact, the expressions “first”, “second”, etc. can be used interchangeably. For example, the control information may also be referred to as second information without departing from the scope of the disclosure, and similarly, the second information may also be referred to as first information.

Further, it can be understood that although operations are depicted in a particular order in the accompanying drawings in the examples of the disclosure, the operations should not be construed as requiring that such operations are executed in the particular order shown or in a serial order, or that all illustrated operations are executed to achieve desired results. In a particular environment, multitasking and parallel processing may be advantageous.

Those skilled in the art could easily conceive of other implementation solutions of the disclosure upon consideration of the description and the invention disclosed in the implementation. The disclosure is intended to cover any variations, uses or adaptive changes of the disclosure, which follow the general principles of the disclosure and include common general knowledge or customary technical means, which is not disclosed in the disclosure, in the technical field. The description and the examples are to be regarded as illustrative only, and the true scope and spirit of the disclosure are indicated by the appended claims.

It should be understood that the disclosure is not limited to a precise structure which has been described above and illustrated in the accompanying drawings, and may have various modifications and changes without departing from the scope of the disclosure. The scope of the disclosure is limited by the appended claims only.

1. A method for selecting resources based on assistance information, performed by a first user equipment (UE), comprises:
sending control information, wherein the control information comprises field information configured to determine a second UE, and the second UE provides assistance information for the first UE.

2. The method for selecting resources based on assistance information according to claim 1, wherein the field information comprises at least one of:
a geographical location zone identity,
a probability factor, or
an identity of the first UE.

3. The method for selecting resources based on assistance information according to claim 2, wherein a probability factor set comprises one or more probability factors, the probability factor set is determined based on at least one of UE identities or cell identities, and at least one of UE identity or cell identity have/has a corresponding probability factor set.

4. The method for selecting resources based on assistance information according to claim 2, wherein a probability factor set comprises one or more probability factors, and the probability factor set is a probability factor set corresponding to a UE identity of the second UE, or a probability factor set corresponding to a cell identity of a cell to which the second UE belongs.

5. The method for selecting resources based on assistance information according to claim 1, wherein the field information comprises at least one of:
a reference signal receiving power threshold;
an angle value between a transmitted signal and a received signal between UE; or
an identity of the first UE.

6. The method for selecting resources based on assistance information according to claim 5, wherein at least one of the reference signal receiving power threshold or the angle value are/is determined based on a preconfigured parameter set, the parameter set is determined based on at least one of UE identities or cell identities, and at least one of UE identity or cell identity have/has a corresponding parameter set.

7. The method for selecting resources based on assistance information according to claim 6, wherein at least one of the reference signal receiving power threshold or the angle value are/is determined based on the preconfigured parameter set, and the parameter set is a parameter set corresponding to a UE identity of the second UE or a parameter set corresponding to a cell identity of a cell to which the second UE belongs.

8. The method for selecting resources based on assistance information according to claim 1, wherein the field information comprises at least one of: one or more groupcast member identities, or an identity of the first UE.

9. The method for selecting resources based on assistance information according to claim 1, wherein the sending control information comprises:
broadcasting second stage sidelink control information.

10. The method for selecting resources based on assistance information according to claim 1, further comprising:
receiving assistance information provided by the second UE, and selecting the resources based on the assistance information.

11. A method for selecting resources based on assistance information, performed by a second user equipment (UE), comprises:
receiving control information sent by a first UE, wherein the control information comprises field information configured to determine the second UE; and
providing assistance information for the first UE based on the field information comprised in the control information.

12. The method for selecting resources based on assistance information according to claim 11, wherein the field information comprises at least one of: a geographical location zone identity, a probability factor or an identity of the first UE; and
the providing assistance information for the first UE based on the field information comprised in the control information comprises:
providing the assistance information for the first UE identified by the identity, wherein the second UE is a UE in a zone identified by the geographical location zone identity, and a probability factor randomly generated and the probability factor comprised in the control information satisfy a preset size relation.

13. The method for selecting resources based on assistance information according to claim 11, wherein the field information comprises at least one of: a reference signal receiving power threshold, an angle value between a transmitted signal and a received signal between UEs, or an identity of the first UE; and
the providing assistance information for the first UE based on the field information comprised in the control information comprises:
providing the assistance information for the first UE identified by the identity, wherein a measured reference signal receiving power value of the second UE satisfies the reference signal receiving power threshold, or a measured angle value of the second UE satisfies the angle value comprised in the control information.

14. The method for selecting resources based on assistance information according to claim 11, wherein the field information comprises at least one of: one or more groupcast member identities or an identity of the first UE; and
the providing assistance information for the first UE based on the field information comprised in the control information comprises:
providing the assistance information for the first UE identified by the identity, wherein a member identity of the second UE is the same as a member identity comprised in the control information.

15. The method for selecting resources based on assistance information according to claim 11, wherein the receiving control information sent by a first UE comprises:
receiving second stage sidelink control information broadcast by the first UE.

16. (canceled)

17. (canceled)

18. An apparatus for selecting resources based on assistance information, comprising:
a processor; and
a memory configured to store a processor-executable instruction, wherein
the processor is configured to:
send control information, wherein the control information comprises field information configured to determine a second user equipment (UE), and
the second UE provides assistance information for a first UE.

19. An apparatus for selecting resources based on assistance information, comprising:
a processor; and
a memory configured to store a processor-executable instruction, wherein
the processor is configured to execute the method for selecting resources based on assistance information of claim 11.

20. A non-transitory storage medium, storing an instruction, wherein the instruction in the storage medium enables a first user equipment (UE) to execute the method for selecting resources based on assistance information of claim 1 when executed by a processor of the first UE.

21. A non-transitory storage medium, storing an instruction, wherein the instruction in the storage medium enables a second user equipment (UE) to execute the method for selecting resources based on assistance information of claim 11 when executed by a processor of the second UE.

22. The method for selecting resources based on assistance information according to claim 11, wherein the field information comprises at least one of: a reference signal receiving power threshold, an angle value between a transmitted signal and a received signal between UEs, or an identity of the first UE; and
the providing assistance information for the first UE based on the field information comprised in the control information comprises:
providing the assistance information for the first UE identified by the identity, wherein a measured reference signal receiving power value of the second UE satisfies the reference signal receiving power threshold, and a measured angle value of the second UE satisfies the angle value comprised in the control information.
